(19) United States
(12) Patent Application Publication
(10) Pub. No.: US 2018/0338509 A1
(43) Pub. Date: Nov. 29, 2018

(54) FILLING SYSTEM FOR A TEXTURED BEVERAGE

(71) Applicant: La Colombe Torrefaction, Inc., Philadelphia, PA (US)

(72) Inventor: Todd Carmichael, Gladwyne, PA (US)

(73) Assignee: La Colombe Torrefaction, Inc., Philadelphia, PA (US)

(21) Appl. No.: 15/989,563

(22) Filed: May 25, 2018

Related U.S. Application Data
(60) Provisional application No. 62/511,477, filed on May 26, 2017.

(51) Int. Cl. A23L 2/40; A23L 2/54; A23L 2/44; A23F 5/24; B67C 7/00; B67C 3/02; B67C 3/30

(52) U.S. Cl. CPC A23L 2/40; A23L 2/54; A23L 2/44; A23F 5/243; B67C 2007/0066; B67C 3/02; B67C 3/30; A23V 2002/00; B67C 2007/006; B67C 7/0006

(57) ABSTRACT

A process for packaging pressurized beverages. The process includes mixing liquid, a solute that depresses the freezing point of the liquid, and gas. Next, the liquid-gas mixture is allowed to rest. Then, retail containers are filled with the mixture. During the mixing and filling steps of the process, the liquid-gas mixture is subjected to pressures that are higher than atmospheric pressure. Unfortunately, such pressure cannot be maintained when the container is transferred from the filling station to the sealing station causing dissolved gas to leave the liquid and foam to overflow the container during the transfer. To prevent such an overflow, prior to the transfer, the dissolved gas is put to sleep by reducing the temperature of the liquid to below 0° C. (32° F.) and optionally allowing the liquid-gas mixture to rest. The liquid beverage may include milk, coffee, tea, fruit juice, chocolate or mixtures thereof, and may include a gum.

### RELATED APPLICATION

This application claims the benefit of priority to U.S. Provisional Patent Application Ser. No. 62/511,477, filed on May 26, 2017, the contents of which are incorporated in this application by reference.

### TECHNICAL FIELD

The present invention relates generally to pressurized beverages, and particularly to a pressurized milk and coffee beverage which, when opened, stretches into a texturized/aerated beverage with a silky drinkable foam phase on top of a liquid phase. The invention further relates to a system and method for producing the pressurized beverage in a can.

### BACKGROUND

Textured or aerated milk, also sometimes referred to as stretched milk, steamed milk, or milk froth, is a common component of many beverages, particularly professionally prepared coffee beverages, such as lattes and cappuccinos, and milk substitute beverages, such as smoothies. As used herein, the term “milk” may be used refer to dairy milk, such as cow milk, or non-dairy milk such as almond milk, coconut milk, soy milk, etc. Traditionally, textured milk is produced by inserting a steam wand into a container of milk and then adding steam to warm the milk and introduce air bubbles to aerate and emulsify the milk. Other methods of producing textured milk are known including aerating warm milk with a handheld device such as an immersion blender or even a whisk, though typically with less desirable results.

Many products are available purporting to include a canned latte or cappuccino beverage. However, these products suffer from any of a number of flaws, including little to no milk texture, or a very short hard and dry foam floating on top. For example, one technique that only produces a dry hard foam is disclosed in International Patent Publication No. WO 1996/33618 and involves supersaturating the milk with a gas, typically a nitrogen oxide (NOₓ) in a large pressure chamber prior to packaging and then quickly capturing the expanding liquid in a can or bottle. The outcome of this technique produces product waste and inferior results as a significant amount of gas may escape from the product resulting in a retail product that forms a thin layer of dry hard foam comprised of bubbles containing air on the top of the beverage—not a thick silky and creamy foam comprised mostly of bubbles containing the dissolved gas.

The main problem of producing textured beverages on a commercial scale is how to package the textured beverage so that when the retail container is opened the textured beverage separates into a liquid phase and a drinkable foam phase. Textured beverages are typically produced under significant pressure with product containers typically filled under pressure. The producer has problems during the transfer of the textured beverage product from a filler to a sealer without subjecting the product to atmospheric pressure, i.e., reducing the pressure to which the product is subject, without the loss of a significant amount of dissolved gas in the beverage. The retention of the gas is desired so that when the retail container is opened the beverage separates into a liquid phase and a drinkable foam phase.

When the pressurized beverage is subjected to atmospheric pressure, gas laws, including Henry's Law and the Stokes' Equation, predict what happens next. Dissolved gas pours out of the liquid and forms a rapidly rising foam. The foam begins to overflow until the container is capped. During manufacturing, this overflow creates spillage, which can ruin machinery, as well as lead to product waste and loss of dissolved gas from the liquid, and consequently, is costly and inefficient. In the finished product, the loss of the dissolved gas in the liquid results in a thin dry undesirable foam when the sealed container is eventually opened for consumption. Such undesirable foam quickly dissipates as it is typically comprised of bubbles containing air instead of the desired dissolved gas.

Methods exist for creating a textured milk beverage packaged in a sealed container, which, when dispensed from the sealed container provides a textured milk beverage without requiring manual or steam aeration as described previously. Specifically, these methods incorporate a fixed one-way valve through the structure of the container, which permits the introduction of gas during packaging. See, e.g., WO 2016/179483. Although the incorporation of a fixed one-way valve addressed certain problems with creating packaged textured milk beverages, it could potentially be a soft spot in the structure of the container, which may negatively impact the shelf life of the retail product.

Accordingly, the invention provides a method of packaging a liquid beverage in a retail container, which does not incorporate a hole in the retail container through which a fixed one-way valve passes, but creates a textured milk beverage packaged in a sealed retail container that may provide for a longer shelf life in the retail setting.

### SUMMARY

An embodiment of the invention provides a process for packaging a pressurized liquid beverage containing a gas and a solute, e.g., sugar or alcohol, that depresses the freezing point of the liquid beverage comprising seven (7) steps. First, the liquid and the solute are mixed to create a liquid mixture. Second, the gas is introduced to the liquid mixture in a sealed container, which may cause the pressure in the container to be greater than 101325 Pa (1 atmosphere). Third, the liquid mixture is agitated so that the gas dissolves in the liquid to create a saturated and in some embodiments super saturated liquid-gas mixture. Fourth, the liquid gas mixture is cooled to or lower than about 0° C. (32° F.) to create a cooled liquid-gas mixture and allowed to rest for a period of time, e.g., for up to 2 hours. Fifth, after the rest period, the cooled liquid-gas mixture is transferred to a retail container. Sixth, and after the rest period, the cooled liquid-gas mixture in the retail container is exposed to atmospheric pressure. Seventh, the cooled liquid-gas mixture is finally sealed in the retail container wherein the pressure inside the retail container after sealing is greater than 101325 Pa (1 atmosphere).

Another embodiment of the invention provides a process for packaging a pressurized liquid beverage, containing a gas and a solute, e.g., sugar or alcohol, that depresses the freezing point of the liquid comprising eight (8) steps. First, the liquid and the solute are mixed to create a liquid mixture. Second, the liquid mixture is filled into a container. Third, the container is sealed with a first cap that contains a one-way valve. Fourth, the gas is introduced through the one-way valve to the liquid mixture, causing the pressure in the container to be greater than 101325 Pa (1 atmosphere) of pressure. Fifth, the liquid mixture is agitated to create a liquid-gas mixture. Sixth, the liquid gas mixture is cooled to about 0° C. (32° F.) to create a cooled liquid-gas mixture and allowed to rest for a time period, e.g., up to two hours. Seventh, the first cap is removed thereby exposing the cooled liquid-gas mixture in the container to atmospheric pressure. Eighth, the cooled liquid-gas mixture is sealed in the container with a second cap which does not contain a one-way valve, wherein the pressure inside the container after sealing is greater than 101325 Pa (1 atmosphere).

A further embodiment of the invention provides a process for packaging a pressurized liquid beverage, containing a gas and a solute that depresses the freezing point of the liquid, comprising eight (8) steps. First, the liquid and the solute are mixed to create a liquid mixture. Second, the liquid mixture is filled into a retail container. Third, the retail container is sealed with a first cap that contains a one-way valve. Fourth, the gas is introduced through the one-way valve into the liquid mixture, causing the pressure in the retail container to increase to more than 101325 Pa (1 atmosphere). Fifth, the liquid mixture is agitated to create a liquid-gas mixture. Sixth, the liquid gas mixture is cooled below the freezing point of the liquid gas mixture to create a frozen liquid-gas mixture. Seventh, the first cap is removed thereby subjecting the frozen liquid-gas mixture in the container to atmospheric pressure. Eighth, the frozen liquid-gas mixture is sealed in the container with a second cap which does not contain a one-way valve and the temperature is increased above the freezing point of the liquid-gas mixture, which raises the pressure inside the container to greater than 101325 Pa (1 atmosphere).

Another embodiment of the invention provides a system for packaging a pressurized liquid beverage, containing a gas and a solute, e.g., sugar or alcohol, that depresses the freezing point of the liquid, comprising an ingredient-mixing tank 310 in fluid communication with a gas saturation tank 330, which is in contact with at least one heat exchanger 320. The gas saturation tank 330 is in fluid communication with a pressurized filler 340 that is connected to a sealer 360 via a conveyor 350. In this embodiment, the final product is created in the following way. First, a drinkable liquid and a solute that reduces the freezing point of the liquid are introduced into the ingredient mixing tank 310 to create a liquid mixture. The liquid mixture then flows to the gas saturation tank. In the gas saturation tank, a gas is introduced to the liquid mixture at pressures greater than 101325 Pa (1 atmosphere) and the liquid mixture is agitated to create a gas-liquid mixture. The temperature of the gas-liquid mixture is reduced to about 0° C. (32° F.) to create a cooled gas-liquid mixture and the gas-liquid mixture is allowed to rest for up to two hours. The cooled gas-liquid mixture flows to the filler where it is deposited into containers under pressures greater than 101325 Pa (1 atmosphere) to create a filled container. The filled container then traverses a conveyor, during which time the filled container is subject to atmospheric pressure, to a sealer. The sealer seals the filled container.

In all embodiments of the invention, when the retail container is opened, thereby releasing its seal, the gas pours out of the liquid phase. This causes the liquid beverage to increase in volume and to separate into a liquid phase and a drinkable foam phase. The liquid beverage may include milk, coffee, fruit juice, chocolate, alcohol, tea, or mixtures thereof. In one embodiment particularly, the liquid includes a mixture of milk, coffee, and chocolate. The liquid may further include a gum. The gum may be any one of acacia gum, guar gum, locust bean gum, carrageenan, pectin, xanthan gum, or mixtures thereof. Agitating the liquid beverage with gas occurs inside a sealed container and may occur simultaneously with increasing the volume of gas. The volume of gas may include nitrous oxide or any other gas that is generally recognized as safe (“GRAS gas”).

The foam phase may persist for at least 10 minutes after the soluble gas expands when the retail container is opened. The pressure inside the retail container after sealing is at least greater than 101325 Pa (1 atmosphere), between 137895 Pa (20 psi) and 586054 Pa (85 psi). Alternatively, the pressure inside the container after sealing is between 137895 Pa (20 psi) and 413685 Pa (60 psi). The liquid beverage may be fully saturated or almost fully saturated with gas after sealing. Furthermore, the final container in which the liquid beverage is packaged can be a can, bottle, keg, or any other suitable container.

### BRIEF DESCRIPTION OF DRAWING

The invention is best understood from the following detailed description when read in conjunction with the accompanying drawings. It is emphasized that, according to common practice, the various features of the drawing are not to scale. On the contrary, the various features are arbitrarily expanded or reduced for clarity. Included in the drawing are the following figures:

FIG. 1 is a flow chart of a process for producing a pressurized beverage, according to a first exemplary embodiment of the invention.

FIG. 2 is a flow chart of a process for producing a pressurized beverage, according to a second exemplary embodiment of the invention.

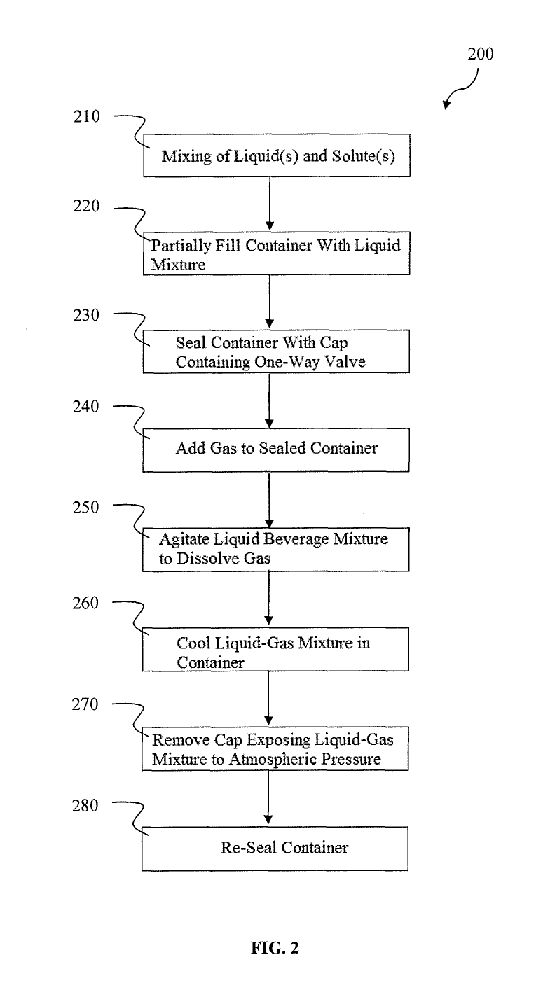

FIG. 3 is a flow chart for one embodiment of the functionality of the system.

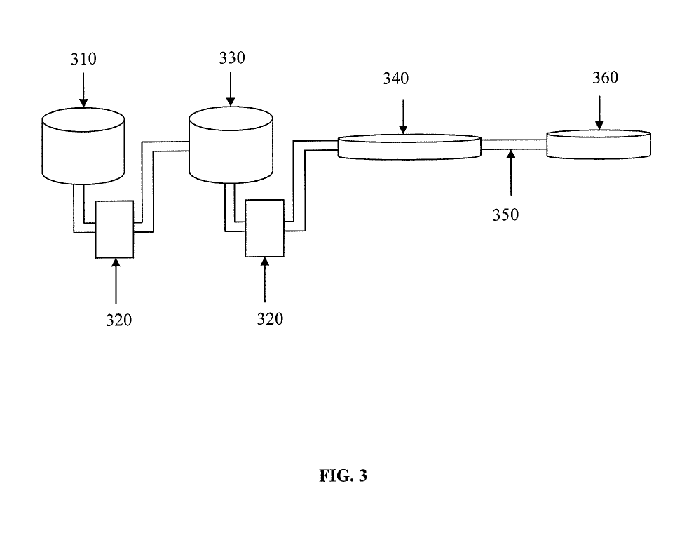

### DETAILED DESCRIPTION

Embodiments of the invention include beverages packaged in a sealed, pressurized container that contains no fixed valves or apertures. When the container is opened, the contents, comprising liquid and gas, expand in volume as the internal pressure of the container is released, thereby permitted the gas saturated in the liquid to expand. This causes the liquid to separate into a liquid phase and a stable textured drinkable foam phase above the liquid phase. The beverage may include milk or a milk substitute, and may also include coffee or tea. Embodiments further include processes and systems for achieving the result described above. Specifically, the embodiments employ temperatures from about 0° C. to below the liquid-gas mixture's freezing point. Pursuant to gas laws, such as Henry's Law and the Stokes' Equation, such a decrease in temperature slows the creation, buildup, and eventual overflow of foam caused by the rapid release of saturated or super saturated gas in the beverage. By delaying foam creation and buildup, even if the delay achieved is less than eight (8) seconds, the container may be sealed before significant gas loss and/or overflow, thereby avoiding the waste associated with, and damage caused by, foam overflowing the container and the loss of an amount of dissolved gas, which negatively affects foam formation when the liquid beverage is eventually consumed. Although a longer delay of foam overflow is desired, delays of as short as four (4) seconds have provided the necessary window to seal the retail container before significant overflow or gas loss occurs.

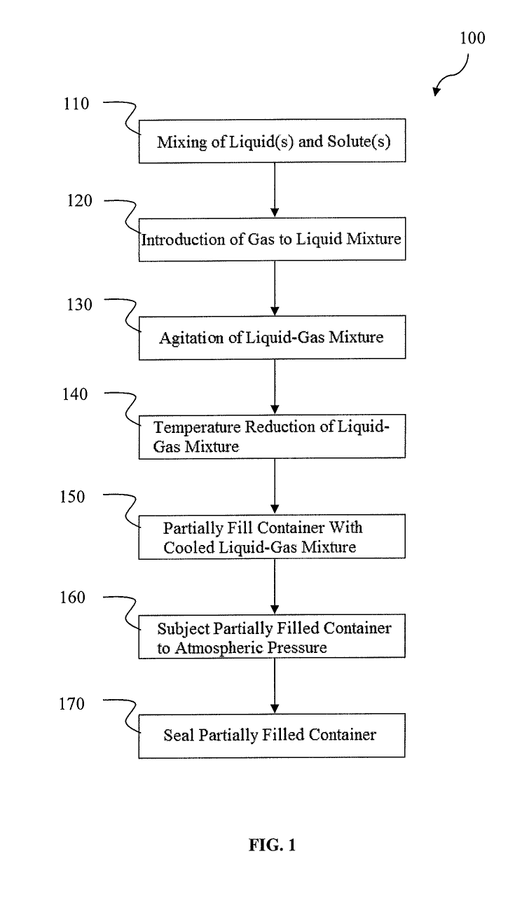

Referring now to the drawings, in which like reference numbers refer to like elements throughout the various views that comprise the drawings, FIG. 1 depicts a process 100 including steps 110-170 for preparing and packaging a pressurized beverage. Although the steps are listed in a given order (i.e., first, second, third, etc.), it will be understood that some steps may be performed out of this given order and that other process steps may be interposed between steps 110-170 unless otherwise noted. For example, the process may include a heat exchanger step before step 110 or between steps 110 and 120 whereby the temperature of the liquid beverage or liquid solute mixture is reduced to about 0° C.

Mixing Tank

At the first step 110 of the process 100, a beverage container is filled with a beverage and a solute that depresses the freezing point of the liquid. The beverage container may be one of any number of vessels suitable for mixing or storage. It can also be sealed or unsealed, and pressurized or open.

In some embodiments, the liquid beverage may include at least a base liquid and optionally a gum. In other embodiments, the gum may not be included. In an exemplary embodiment, the gum is acacia gum (also referred to as gum arabic), guar gum (also referred to as guaran), locust bean gum (also known as carob gum), pectin, xanthan gum, or mixtures thereof. Other gums are also suitable, such as carrageenan. The gum may be added to the liquid beverage in a concentration ranging from approximately 0.05 wt. % to approximately 10 wt. %. As described in more detail below, the gum is added as a popping inhibitor which allows bubbles to form and grow into a stable drinkable foam when the beverage container is opened. In one non-limiting embodiment, the gum further acts as an emulsifier.

The amount of gum added to the beverage will depend on the base liquid, as well as the desired characteristics of the foam. Base liquids that are naturally more viscous will require less gum, or in some cases no gum at all, in order to achieve the same effect.

The addition of gum to the base liquid serves at least three purposes. First, it thickens the base liquid in a way that may be more palatable. Second, once the container is opened, the gum traps the gas that exits the base liquid and forms bubbles. Some base liquids are sufficiently viscous to foam without the addition of gum, but the foam phase duration is greatly increased by the gum. The gum further serves as a limiter on bubble size by forming a stronger, thicker bubble wall which resists stretching by the trapped gas. This results in finer bubbles which are perceived as silkier and creamier than foams with large bubbles. In situations where the resulting beverage will be consumed immediately, the foam phase may persist for a sufficient duration without the addition of gum to the liquid beverage.

In an exemplary embodiment, the base liquid of the liquid beverage is milk. In some embodiments, the term “milk” refers to dairy milk and non-dairy milk. For example, dairy milk can be an animal milk including milk proteins and fat, such as, for example, cow's milk. In other embodiments, the milk may be a reconstituted mixture of milk proteins and milk fat. In further embodiments, the liquid may include one or more non-dairy milks such as almond milk, coconut milk, soy milk, etc. The non-dairy milks have fat and protein concentrations similar to dairy milk. In still other embodiments, the liquid may include other dairy products such as yogurt. The milk used in the liquid beverage may initially have any concentration of fat including approximately 1 wt. % or approximately 2 wt. % (e.g., reduced fat milks), approximately 3.25 wt. % (e.g., whole milk), approximately 10.5 wt. % to approximately 18 wt. % (e.g., “half and half”), or greater than approximately 18 wt. % (e.g., cream).

Non-dairy liquids are also suitable as the base liquid of the liquid beverage, such as water, coffee, tea, or fruit juices (e.g., orange juice). The liquid beverage may further include solutes that depress the freezing point of the liquid such as sweeteners (e.g., sugar, honey, artificial, non-saccharide sweeteners, etc.) and artificial or natural flavoring agents (e.g., mint, cinnamon, caramel, hazelnut, chocolate, etc.). The solutes may also be sugars, salts, acids, gas, gums, stabilizers, emulsifiers, flavors, preservatives, starches, flours, electrolytes, alcohol, or a mixture thereof. In a non-limiting embodiment, the solutes may comprise between about 0.05% and about 5.0% of the total weight of the liquid. In another embodiment, the solutes comprise between about 0.1% and about 3.0% of the total weight of the liquid. In another embodiment, the solutes comprise between about 0.3% and about 1.5% of the total weight of the liquid.

In an exemplary embodiment, the liquid beverage is a mixture of milk or milk substitute and coffee in any suitable ratio. For example, coffee is mixed with whole milk at a milk-to-coffee weight ratio ranging from approximately 4:1 to approximately 5:1. In other words, the liquid beverage may include approximately 15 wt. % to approximately 25 wt. % of coffee and approximately 80 wt. % to approximately 90 wt. % milk or milk substitute. The coffee may be brewed using any suitable method known to one of ordinary skill in the art, including, but not limited to, espresso, drip brewing, or cold brewing. In a preferred embodiment, the coffee is cold brewed with a brew strength, measured as the percentage of total dissolved solids, of approximately 7 parts per million (ppm).

The liquid beverage may be prepared by slowly mixing the gum and the base liquid until the gum is well dissolved. The base liquid and gum are mixed at a rate low enough to avoid dissolving air into the mixture at 15.6° C. (60° F.) and 101325 Pa (1 atmosphere). Where the base liquid is a mixture of liquids, the gum may be dissolved into a first liquid before a second liquid is added to the mixture. For example, for a mixture of coffee and milk, the gum may first be dissolved in the coffee. The milk is then added to the coffee-gum mixture and again slowly mixed to incorporate without dissolving air in the mixture. In other embodiments, the liquid beverage may be mixed in any other order, including first mixing together the milk and the coffee and then adding the gum. In some embodiments, the liquid beverage may be ultrasonicated to remove any dissolved air before or after filling the retail container, but before sealing the retail container.

Gas Saturation Tank

At the second step 120 of the process 100, the mixing tank is sealed or the liquid mixture is transferred to a sealed gas saturation tank such that the tank forms a gas tight system. It will be understood that the mixing tank and the gas saturation tank may be the same tank. In one exemplary embodiment, the tank is a circulatory agitation system which includes a tank and a pump, in which the liquid beverage and gas are able travel from the tank and through the pump before returning to the tank. Once sealed, the headspace may contain air at approximately atmospheric pressure (i.e., approximately 14.7 pounds per square inch (psi) at sea level). In another embodiment, the headspace may be purged of air such that the headspace has a reduced pressure of less than atmospheric pressure.

A volume of a gas is introduced into the gas saturation tank through a valve. In one embodiment, the gas is nonreactive to prevent the gas from altering the flavor of the liquid beverage. In an exemplary embodiment, the gas is nitrous oxide (N₂O), nitrogen (N₂), carbon dioxide (CO₂) or argon (Ar). In contrast to a nonreactive gas like nitrous oxide, carbon dioxide reacts with water to form carbonic acid, which may alter the flavor of the beverage. Accordingly, in another embodiment, carbon dioxide may be used to increase the acidity or alter the flavor of the liquid beverage. After the gas is introduced into the tank, it may naturally collect in the headspace rather than being dissolved into the liquid resulting in a head pressure of equal to or greater than 101325 Pa (1 atmosphere).

At the third step 130 of the process 100, the liquid beverage, now sealed in the tank, is agitated to dissolve a portion of the gas in the liquid beverage. The liquid beverage may be agitated by agitating the tank or by agitating only the liquid beverage within the tank. As the gas is dissolved, it will move from the headspace into the liquid beverage, thereby reducing the pressure in the headspace. Further gas is added and the beverage container is agitated until the liquid beverage is fully saturated by the gas. Saturation may be determined by measuring the pressure within the headspace. When the pressure in the headspace is not reduced by further agitation, no more gas can be dissolved into the liquid beverage. The gas may be added to the sealed beverage container continuously while agitating the liquid beverage or in a stepwise manner, where gas is added to the tank between periods of agitation. Simultaneous addition of gas and agitation is preferred. After the liquid beverage is fully saturated by the gas, the pressure in the tank ranges from approximately 137895 Pa (20 psi) to 586054 Pa (85 psi), from approximately 137895 Pa (20 psi) to 413685 Pa (60 psi), or from approximately 137895 Pa (20 psi) to 275790 Pa (40 psi). Without agitation, the gas will collect in the headspace rather than dissolve in the liquid beverage. Because undissolved gas will not form bubbles in the liquid beverage once the beverage container is opened, reducing or eliminating agitation will result in reduced foam production.

Because the amount of the gas which can be dissolved in the liquid beverage is dependent on the temperature of the liquid beverage, steps 120 and 130 may occur at the temperature at which the product will be stored and served to prevent too little or too much of the gas being dissolved in the liquid beverage during packaging. In some embodiments, the liquid beverage has a temperature ranging from approximately −28.9° C. (−20° F.) to approximately 4.4° C. (40° F.) during gassing and agitation. Alternatively, the liquid beverage has a temperature ranging from approximately −17.8° C. (0° F.) to approximately 4.4° C. (40° F.) during gassing and agitation. In another alternative, the liquid beverage has a temperature ranging from approximately −3.9° C. (25° F.) to approximately 4.4° C. (40° F.) during gassing and agitation. The liquid beverage may have a temperature ranging from approximately −3.9° C. (25° F.) to approximately 0.5° C. (33° F.) during gassing and agitation. In an exemplary embodiment, the liquid-gas mixture may be frozen.

In some embodiments, the liquid-gas mixture may be allowed to rest. Such resting may occur for anywhere up to about 15, 30, 45, 60, 75, 90, 105, or 120 minutes. In other embodiments, the liquid-gas mixture is permitted to rest for up to about 3, 4, 5, or 6 hours. In an exemplary embodiment, the liquid-gas mixture may be frozen during the time it is resting. Such resting may occur before, during, or after the cooling step. In another embodiment, the resting may occur before or after the filing step, but prior to the exposure of the liquid-gas mixture to atmospheric pressure.

Heat Exchanger

At the fourth step 140 of the process 100, the temperature of the liquid-gas mixture is reduced to about 0° C. (32° F.). At constant pressure, Henry's Law teaches that as the temperature goes down the solubility of the gas increases. When pressure is reduced, however, solubility will decrease and dissolved gas will begin to flow out of the liquid phase. By increasing the pressure the applicant is increasing the solubility before reducing the pressure, which will in turn decrease the solubility.

In certain embodiments, heat exchangers 320, such as glycol heat exchangers, may be used to reduce the temperature of the liquid. Heat exchangers 320 may be placed between the mixing tank and the gas saturation tank 330 or between the gas saturation tank 330 and the pressurized filler 340 discussed below.

Pressurized Filler

At the fifth step 150 of the process 100, the cooled liquid-gas mixture is introduced to a retail container. As the cooled liquid-gas mixture contains dissolved gas, turbulence, which would start the foaming process, should be avoided. In addition, the container may be only partially filled with the liquid beverage such that a headspace remains above the liquid beverage. In an exemplary embodiment, the volume of the liquid beverage ranges from approximately 65% to approximately 95% of the volume of the beverage container, with the headspace forming the balance of the volume of the beverage container (i.e., approximately 5% to approximately 35% of the volume).

The retail container may be one of any number of vessels suitable for packaging beverages that may be sealed, pressurized with a gas, and reopened as described in more detail below, such as cans, bottles, kegs, etc. In the exemplary embodiment, the container is a metal (e.g., aluminum) can, bottle, or keg. Glass or ceramic bottles may also be used.

In one embodiment of this invention turbulence is avoided by minimizing the height difference between the surface of the liquid in the can and the surface of the liquid in the tank. Such minimization can be accomplished in one of two ways, both of which require monitoring of the height of the surface in the tank. First, as the cooled liquid-gas mixture flows out of the tank, the tank may be lifted via a motorized tank elevation system. Second, the flow of the cooled liquid-gas mixture to the tank could be set to equal the flow of the cooled liquid-gas mixture to the filler thereby maintaining a steady height. Regardless of the strategy employed, it is desirable to maintain the difference in the height of the surface of the liquid in the tank and the container between approximately 5.1 cm (2 in) and 30.5 cm (12 in).

In another embodiment of this invention, the liquid mixture may bypass the gas saturation tank 330 and be introduced directly to a container via the pressurized filler 340. The container may be initially sealed with a cap containing a one-way valve. The cap may be a one-time use cap or reusable. Gas is then introduced to the liquid mixture in the container and the liquid mixture is agitated to create a gas-liquid mixture. The temperature of the gas-liquid mixture is then reduced to about 0° C. (32° F.) to put the dissolved gas to sleep. The introduction of the gas may occur at substantially the same time that the liquid mixture is agitated or cooled. In addition, the gas may be introduced into the liquid mixture, the mixture may be agitated, and the temperature of the gas-liquid mixture may be reduced to about 0° C. (32° F.) all at substantially the same time.

In a further non-limiting embodiment, the temperature of the gas-liquid mixture is reduced below the freezing point of the gas-liquid mixture. While the gas-liquid mixture is frozen, a cap containing a one-way valve may be removed and replaced with a standard cap.

The use of a reusable cap with a one-way valve permits the container to be adapted to allow gas to be introduced into the container after it is sealed. In an exemplary embodiment, the one-way valve is incorporated into the top of the cap. However, other embodiments may include the one-way valve located in any other suitable location, for example the side of the cap. The one-way valve, for example, may be a permeable membrane through which a syringe can be introduced into the interior of the first container but which does not allow gas or liquid to exit the first container. The one-way valve may be an FDA-approved gassing valve. In other embodiments, any other one-way valve may be used.

Conveyor

At the sixth step 160 of the process 100, the retail containers containing the cooled gas-liquid mixture are transmitted from the filler to the sealer. On the conveyor and in the sealer, the pressure that the containers are subject to is reduced to atmospheric pressure. In one embodiment of this invention, the conveyor is approximately 1.2 m (4 ft) long. In such embodiments the containers traverse the length of the conveyor in approximately 2 seconds. It is during this time that the gas dissolved in the liquid-gas mixture comes out of solution and begins to create a foam which will eventually overflow the container if the container is not sealed.

Sealer

At the seventh step 170 of the process 100, the container containing the liquid-gas mixture is sealed so that pressure cannot escape. When the containers reach the sealer they are almost immediately sealed. Once sealed, the gas that has been released as a result of the drop in pressure to atmospheric pressure equilibrates as certain amounts dissolve back into the liquid-gas mixture thereby preserving the ability of the liquid-gas mixture to separate into a delicious liquid and foam upon the opening of the sealed container.

In other embodiments in which the container is initially sealed with a cap containing a one-way valve, the cap containing a one-way valve is removed and a new cap, which does not contain a one-way valve, is used to seal the container. Once sealed, the gas that has been released as a result of the drop in pressure to atmospheric pressure equilibrates as certain amounts dissolve back into the liquid-gas mixture thereby preserving the ability of the liquid-gas mixture to separate into a delicious liquid and foam upon the opening of the sealed container. The cap containing the one-way valve may then be sterilized and reused.

During the sealing process additional gas and/or beverage product may be introduced to the container. In some embodiments, additional gases are introduced to the beverage after the beverage is exposed to reduced atmospheric pressure (i.e., prior to sealing). These gases may be introduced in solid, liquid or gas form. For example, in one embodiment a drop of liquid nitrogen is introduced to the beverage before sealing. In another embodiment, dry ice could be introduced to the beverage before sealing.

### EXAMPLES

In the following three experiments, the freezing point and gas stability of various beverages was tested.

### Experiment 1—Solute Effect on Freezing Points

In the first set of experiments, the freezing point of three different compositions was investigated. The first composition was a La Colombe Original Draft Latte. The second and third compositions added different solutes (sugar and alcohol) to composition 1. During the experiment, each preparation was carefully weighed and poured into a transparent container equipped with a valve. Next, the container was gassed and shaken with nitrous oxide at 45 psi until saturation occur. Then the gas-liquid mixture was cooled in a freezer. Finally, when the preparation began to freeze, the temperature was recorded using a laser gun thermometer. The results of the first set of experiments is recorded in Table 1 below:

TABLE 1

| | Original Draft | | | | | |
|---|---|---|---|---|---|---|
| | Latte | Sugar | | Alcohol | | Freezing Point |
| Compo- | 270 grams | 0 | grams | 0 | grams | −2.2° C. (28° F.) |
| sition 1 | | | | | | |
| Compo- | 270 grams | 10 | grams | 0 | grams | −2.8° C. (27° F.) |
| sition 2 | | | | | | |
| Compo- | 270 grams | 0 | grams | 10 | grams | −3.9° C. (25° F.) |
| sition 3 | | | | | | |

### Experiment 2—Temperature and Resting Time Effect on Gas Retention

In the second set of experiments, the effect of temperature and rest on the gas retention of the three different compositions was investigated. The basic manipulation included first getting a composition ready and gassed in a first 8 fluid oz. container at 45 PSI, which may be considered as a large scale production container connected to a filler. Next, the container (and the composition) was placed in various conditions of temperature and rest in order to test the effect of these 2 parameters. Specifically, the container was opened to expose the composition to an atmospheric pressure. The composition was poured from the first container into a second 8 fluid oz. container without a valve to simulate the agitation produced by a production filler. The second container was then sealed. To test the gas lost from the exposure to atmospheric pressure, the second container was permitted to rest until it reaches a consuming temperature (45° F.) at which time the container was opened and poured into a beaker. The quantity of foam obtained from each composition was measured in milliliters at set intervals and is listed in Tables 2 below:

TABLE 2

| | | | | Measured at 45° F., volume of foam in ml after: | | | | | | | |
|---|---|---|---|---|---|---|---|---|---|---|---|
| Composition | Temperature | | Rest Time | 0 s | 15 s | 30 s | 1 min | 3 min | 5 min | 10 min | 15 min |
| 1 | 0.6° C. | (33° F.) | 15 min | 500 | 480 | 470 | 410 | 360 | 250 | 40 | 0 |
| | 0.6° C. | (33° F.) | 30 min | 510 | 500 | 490 | 450 | 380 | 270 | 40 | 0 |
| | 0.6° C. | (33° F.) | 90 min | 600 | 580 | 570 | 560 | 440 | 300 | 50 | 0 |
| | 7.2° C. | (45° F.) | 15 min | 450 | 430 | 350 | 300 | 250 | 150 | 10 | 0 |
| | 7.2° C. | (45° F.) | 30 min | 430 | 400 | 330 | 290 | 210 | 150 | 10 | 0 |
| | 7.2° C. | (45° F.) | 90 min | 450 | 440 | 350 | 300 | 230 | 150 | 10 | 0 |
| | 15.6° C. | (60° F.) | 15 min | 150 | 75 | 50 | 50 | 10 | 0 | 0 | 0 |
| | 15.6° C. | (60° F.) | 30 min | 480 | 390 | 350 | 310 | 125 | 60 | 0 | 0 |
| | 15.6° C. | (60° F.) | 90 min | 550 | 470 | 400 | 350 | 180 | 100 | 10 | 0 |
| 2 | 0° C. | (32° F.) | 15 min | 620 | 610 | 610 | 560 | 470 | 430 | 140 | 10 |
| | 0° C. | (32° F.) | 30 min | 620 | 620 | 610 | 600 | 500 | 400 | 190 | 0 |
| | 0° C. | (32° F.) | 90 min | 600 | 590 | 590 | 570 | 490 | 370 | 150 | 10 |
| | 7.2° C. | (45° F.) | 15 min | 500 | 480 | 470 | 430 | 340 | 280 | 80 | 0 |
| | 7.2° C. | (45° F.) | 30 min | 560 | 550 | 530 | 510 | 420 | 320 | 130 | 0 |
| | 7.2° C. | (45° F.) | 90 min | 500 | 490 | 480 | 450 | 360 | 300 | 100 | 10 |
| | 15.6° C. | (60° F.) | 15 min | 370 | 350 | 330 | 290 | 200 | 140 | 10 | 0 |
| | 15.6° C. | (60° F.) | 30 min | 400 | 340 | 320 | 280 | 180 | 110 | 10 | 0 |
| | 15.6° C. | (60° F.) | 90 min | 390 | 370 | 350 | 300 | 190 | 140 | 0 | 0 |
| 3 | −1.1° C. | (30° F.) | 15 min | 620 | 620 | 600 | 580 | 470 | 300 | 40 | 0 |
| | −1.1° C. | (30° F.) | 30 min | 630 | 630 | 600 | 580 | 500 | 330 | 60 | 10 |
| | −1.1° C. | (30° F.) | 90 min | 630 | 630 | 610 | 570 | 500 | 410 | 140 | 10 |
| | 7.2° C. | (45° F.) | 15 min | 480 | 450 | 430 | 310 | 270 | 200 | 30 | 0 |
| | 7.2° C. | (45° F.) | 30 min | 510 | 490 | 470 | 440 | 330 | 210 | 40 | 0 |
| | 7.2° C. | (45° F.) | 90 min | 530 | 500 | 470 | 450 | 340 | 210 | 50 | 0 |
| | 15.6° C. | (60° F.) | 15 min | 450 | 420 | 420 | 350 | 240 | 180 | 50 | 0 |
| | 15.6° C. | (60° F.) | 30 min | 470 | 440 | 400 | 360 | 250 | 180 | 10 | 0 |
| | 15.6° C. | (60° F.) | 90 min | 470 | 450 | 400 | 340 | 240 | 190 | 30 | 0 |

As can be seen above, decreased temperature and rest puts the gas-liquid mixture to sleep, which permits more gas to be retained in between filling and sealing of the container.

### Experiment 3—Temperature and Resting Time Effect on Switch Cap System

In the third set of experiments, the effect of temperature and rest on the gas retention of the original draft latte (Composition 1) using the switch cap system was investigated. The basic manipulation included first getting a composition ready and gassed in a first 12 fluid oz. container at 45 PSI. The container rests for 90 minutes and the temperature is lowered to 0.6° C. (33° F.). The cap is removed, exposing the liquid to atmospheric pressure. The container is then sealed with a standard cap lacking a valve. To test the gas lost from the exposure to atmospheric pressure, the container was permitted to rest until it reaches a consuming temperature (45° F.) at which time the container was opened and poured into a beaker. The quantity of foam obtained from each composition was measured in milliliters at set intervals and is listed in Tables 3 below:

TABLE 3

| | | | Measured at 45° F., volume of foam in ml after: | | | | | | | |
|---|---|---|---|---|---|---|---|---|---|---|
| Composition | Temperature | Rest Time | 0 s | 15 s | 30 s | 1 min | 3 min | 5 min | 10 min | 15 min |
| 1 | 0.6° C. (33° F.) | 90 min | 810 | 780 | 770 | 690 | 640 | 510 | 340 | 90 |
| | 0.6° C. (33° F.) | 90 min | 800 | 790 | 780 | 730 | 650 | 520 | 340 | 110 |
| | 0.6° C. (33° F.) | 90 min | 800 | 790 | 750 | 780 | 580 | 480 | 280 | 80 |
| | 0.6° C. (33° F.) | 90 min | 810 | 800 | 780 | 750 | 650 | 520 | 300 | 90 |
| | 0.6° C. (33° F.)) | 90 min | 800 | 790 | 780 | 670 | 550 | 490 | 320 | 90 |
| | 0.6° C. (33° F.) | 90 min | 780 | 770 | 670 | 650 | 530 | 490 | 250 | 40 |

Although illustrated and described above with reference to certain specific embodiments, the present invention is nevertheless not intended to be limited to the details shown. Rather, various modifications may be made in the details within the scope and range of equivalents of the claims and without departing from the spirit of the invention. It is also expressly intended that the steps of the methods of using the various devices disclosed above are not restricted to any particular order.

What is claimed:

1. A process for the packaging of a pressurized liquid, containing a gas and a solute that depresses the freezing point of the liquid, the process comprising:
mixing the liquid and the solute to create a liquid mixture;
introducing the gas to the liquid mixture, under greater than 101325 Pa (1 atmosphere) of pressure;
agitating the liquid mixture, to create a liquid-gas mixture;
cooling the liquid-gas mixture to less than 0° C. (32° F.) to create a cooled liquid-gas mixture;
transferring the cooled liquid-gas mixture to a container;
subjecting the cooled liquid-gas mixture in the container to atmospheric pressure; and
sealing the cooled liquid-gas mixture in the container wherein the pressure inside the container after sealing is greater than 101325 Pa (1 atmosphere).

2. The process of claim 1, wherein the liquid mixture is cooled to less than 0° C. (32° F.) prior to the introduction of the gas.

3. The process of claim 1, wherein the liquid is agitated at substantially the same time the gas is introduced to the liquid mixture.

4. The process of claim 4, wherein the liquid, solute, and gas are all mixed together at substantially the same time

5. The process of claim 1, wherein the liquid includes milk, coffee, fruit juice, chocolate or mixtures thereof.

6. The process of claim 1, wherein the liquid includes a gum selected from the group consisting of acacia gum, guar gum, locust bean gum, carrageenan, pectin, xanthan gum, or mixtures thereof.

7. The process of claim 1, wherein the solute includes salt, sugar, electrolytes, alcohol, or mixtures thereof.

8. The process of claim 1, wherein the gas includes nitrous oxide.

9. The process of claim 1, wherein the container is a can, bottle, or keg.

10. A process for the packaging of a pressurized liquid, containing a gas and solute that depresses the freezing point of the liquid, the process comprising:
mixing the liquid and the solute to create a liquid mixture;
filling a container with the liquid mixture;
sealing the container with a first cap that contains a one-way valve;
introducing the gas through the one-way valve to the liquid mixture, under greater than 101325 Pa (1 atmosphere) of pressure;
agitating the liquid mixture, to create a liquid-gas mixture;
cooling the liquid gas mixture to less than 0° C. (32° F.) to create a cooled liquid-gas mixture;
removing the first cap, thereby subjecting the cooled liquid-gas mixture in the container to atmospheric pressure; and
sealing the cooled liquid-gas mixture in the container with a second cap which does not contain a one-way valve, wherein the pressure inside the container after sealing is greater than 101325 Pa (1 atmosphere).

11. The process of claim 10, wherein the liquid mixture is cooled to less than 0° C. (32° F.) prior to the introduction of the gas.

12. The process of claim 10, wherein the liquid is agitated at substantially the same time the gas is introduced to the liquid mixture.

13. The process of claim 10, wherein the liquid includes milk, coffee, fruit juice, chocolate, tea, or mixtures thereof.

14. The process of claim 10, wherein the liquid includes a gum selected from the group consisting of acacia gum, guar gum, locust bean gum, carrageenan, pectin, xanthan gum, or mixtures thereof.

15. The process of claim 10, wherein the solute includes salt, sugar, electrolytes, alcohol, or mixtures thereof.

16. The process of claim 10, wherein the gas includes nitrous oxide.

17. The process of claim 10, wherein the second container is a can, bottle, or keg.

18. A system for packaging a pressurized liquid comprising:
an ingredient mixing tank into which a drinkable liquid and a solute that reduces the freezing point of the liquid are introduced to create a liquid mixture;
a gas saturation tank in fluid communication with the ingredient mixing tank permitting the liquid mixture to flow from the ingredient mixing tank to the gas saturation tanks, the gas saturation tank receiving a gas introduced to the liquid mixture at pressures greater than 101325 Pa (1 atmosphere) and in which the liquid mixture is agitated to create a gas-liquid mixture;
a heat exchanger in contact with the gas saturation tank such that the temperature of the gas-liquid mixture is reduced to less than 0° C. (32° F.) to create a cooled gas-liquid mixture;
a pressurized filler in fluid communication with the gas saturation tank which permits the cooled gas-liquid mixture to flow from the gas saturation tank to the pressurized filler;
a container receiving the cooled gas-liquid mixture from the pressurized filler at a pressure greater than 101325 Pa (1 atmosphere) to create a filled container;
a conveyor transmitting the filled container from the pressurized filler during which time the filled container is subject to atmospheric pressure; and
a sealer which seals the container.

19. The system of claim 18, further comprising a heat exchanger that contacts the liquid mixture as the liquid mixture flows between the mixing tank and the gas saturation tank.
